(19) United States
(12) Patent Application Publication
(10) Pub. No.: US 2007/0103450 A1
(43) Pub. Date: May 10, 2007

(54) Touch control bar with button function

(76) Inventors: Kuan-Chun Tang, Toufen Township (TW); Wen-Kai Lee, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/487,384

(22) Filed: Jul. 17, 2006

(30) Foreign Application Priority Data
Nov. 10, 2005 (TW) 094219497

(51) Int. Cl. G09G 5/00

(52) U.S. Cl. 345/173

(57) ABSTRACT

A touch control bar with button function comprises a plurality of scroll sensor areas and at least a button sensor area disposed between two adjacent ones of the scroll sensor areas. On the touch control bar, a virtual button is defined over an area covering at least a button sensor area. The gesture on the touch control bar will determine which function between button and scroll is to be performed.

### FIELD OF THE INVENTION

The present invention is related generally to a touch control bar and, more particularly, to a touch control bar with button function.

### BACKGROUND OF THE INVENTION

Due to its compact size, low cost, low power consumption and long lifetime, touchpad has been widely used as input devices in various electronic products such as notebook computer, mouse, MP3 player and mobile phone, among which touch control bar and touch button are often combined to be utilized in the selection and movement of a list or menu, or the tuning of volume and brightness. However, in conventional electronic products, touch control bar and touch button are usually provided by two separate devices, and therefore on a panel, in addition to LCD display, there is required several button areas and a bar area. FIG. 1 shows a front view of a typical panel with separate touch buttons and touch control bar, in which panel 10 has LCD display 12, several button areas 15 and bar area 17. Since the button areas 15 and the bar area 17 are separated, the panel 10 is limited in both shape and size. FIG. 2 is the sensor area arrangement of the panel 10 shown in FIG. 1, in which button sensor areas 151 are at the positions corresponding to the button areas 15 shown in FIG. 1, and scroll sensor areas 171 are at the positions within the bar area 17 shown in FIG. 1. When the button sensor area 151 senses a touch thereon, it produces and sends out a button signal. When the scroll sensors 171 sense a scroll thereon, a scroll signal is produced and sent out. Disadvantageously, such arrangement limits the area and mechanical design of the panel, and the panel is hard to reduce in size and is more complex. In the trend of minimizing consumer electronic products, there's a need to minimize the panel. Moreover, cost reduction is another vital requirement.

Therefore, it is desired a touch control bar to increase panel design space, to simplify the structure, to minimize the panel size, and to reduce the cost.

### SUMMARY OF THE INVENTION

An object of the present invention is to provide a touch control bar with button function.

Another object of the present invention is to provide a touch control bar having simpler structure.

Still another object of the present invention is to provide a compact size touch control bar.

Yet still another object of the present invention is to provide a low cost touch control bar.

In a touch control bar with button function, according to the present invention, there are provided a plurality of scroll sensor areas and at least a button sensor area, and the button sensor area is disposed between two adjacent ones of the scroll sensor areas. The touch control bar comprises at least a virtual button, which includes at least a button sensor area.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a front view of a typical panel with separate touch buttons and touch control bar;

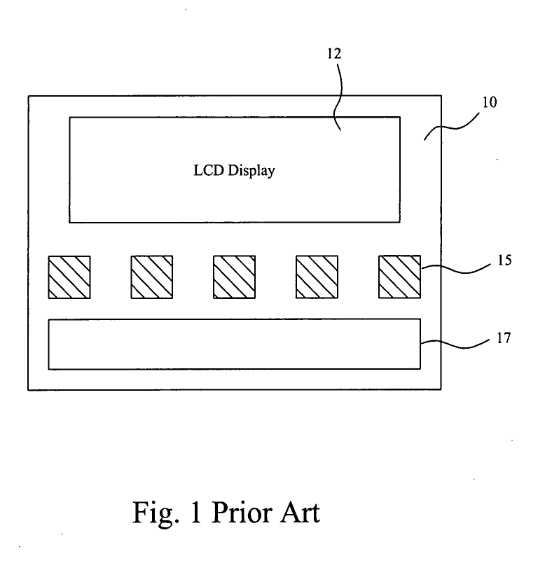

FIG. 2 is the sensor area arrangement of the panel shown in FIG. 1;

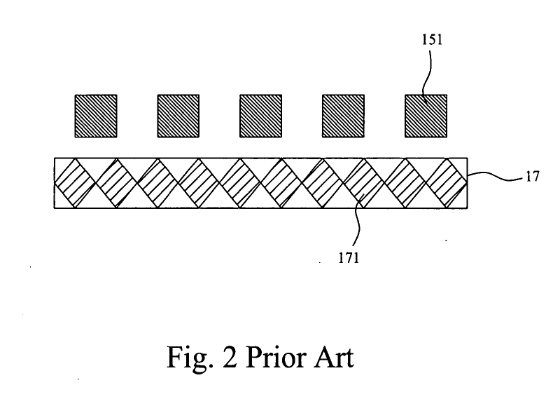

FIG. 3 shows an embodiment according to the present invention; and

FIG. 4 is the sensor area arrangement of the panel shown in FIG. 3.

### DETAIL DESCRIPTION OF THE INVENTION

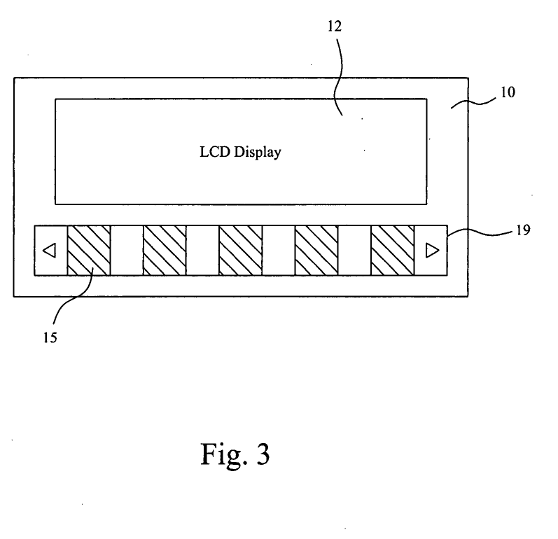

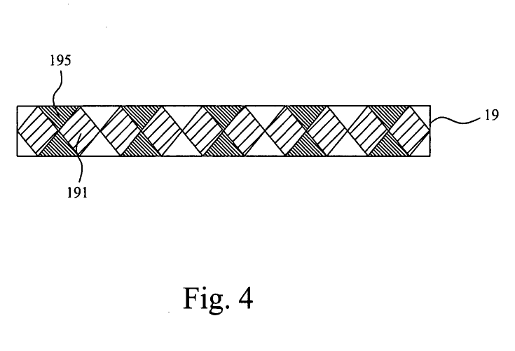

FIG. 3 shows an embodiment according to the present invention, in which panel 10 has LCD display 12 and touch control bar 19 thereon. The touch control bar 19 has a plurality of button areas 15 embedded thereof, and FIG. 4 is the sensor area arrangement of the panel 10 shown in FIG. 3. The touch control bar 19 has a plurality of scroll sensor areas 191, and button sensor area 195 is disposed between two adjacent scroll sensor areas 191. In this embodiment, a button sensor area 195 is composed of an upper region and a lower region, and is defined as a virtual button corresponding to a button area 15. However, in this embodiment, a button area 15 also covers part of the scroll sensor areas 191.

When the touch control bar 19 is operated therewith, the gesture will determine which function is to be performed. If it is sensed touch, click or pressing on the button sensor area 195, the button function is active. Namely, a button signal will be produced and sent out corresponding to that button area 15. If it is sensed scroll on the scroll sensor areas 191, the scroll function is active. Namely, a scroll signal will be produced and sent out corresponding to that scroll gesture. The detection or judgment of the gesture may be implemented by firmware or software as known in the art.

In other embodiments, the shapes and the sizes of the scroll sensor areas 191 and the button sensor areas 195 and the layout of them could be easily designed for each specific application. However, the scroll sensor areas 191 and the button sensor areas 195 are always integrated within the touch control bar 19, and preferably in such a manner that at least a button sensor area 195 is embedded between two scroll sensor areas 191.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation to encompass all such modifications and similar arrangements.

What is claimed is:

1. A touch control bar with button function, comprising:
a plurality of scroll sensor areas; and
at least a button sensor area disposed between two adjacent ones of the scroll sensor areas.

2. The touch control bar of claim 1, wherein the touch control bar has at least a virtual button including at least a button sensor area.
